(19) United States
(12) Patent Application Publication
(10) Pub. No.: US 2008/0257144 A1
(43) Pub. Date: Oct. 23, 2008

(54) Measuring of a Soot Deposition Homogeneity in a Particle Filter and Said Filter Regeneration Control

(75) Inventors: David Pinturaud, Orleans (FR); Caroline Tardivat, Aix-En Provence (FR); Patrick Jacques Dominique Girot, Avigton (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT GOBAIN CENTRE DE RECHERCHES ET D'ETUDES EUR, COURBEVOIE (FR)

(21) Appl. No.: 12/089,670

(22) PCT Filed: Oct. 26, 2006
(86) PCT No.: PCT/FR2006/051110

§ 371 Date: Apr. 9, 2008

(30) Foreign Application Priority Data
Oct. 27, 2005 (FR) 0553268

(51) Int. Cl. B01D 46/44; F01N 3/023; F01N 9/00

(52) U.S. Cl. 95/12; 55/282.3; 422/178; 60/286

(57) ABSTRACT

The invention relates to a method for measuring the uniformity of the deposit of soot in a particulate filter, comprising the steps consisting in measuring, simultaneously or in succession, the respective characteristic quantities of at least two gas streams each having passed through a different longitudinal portion of said filter, and then in comparing the characteristic quantities thus measured. It also relates to a method for controlling the regeneration of a particulate filter, comprising the steps consisting in measuring the uniformity of the soot deposit in said filter and in adjusting the parameters of said regeneration according to the uniformity value obtained.

The invention relates to the field of honeycomb particulate filters used in an engine exhaust line for removing the soot typically produced by the combustion of a diesel fuel in an internal combustion engine. More particularly, the invention relates to a method for measuring the uniformity of a soot deposit in such a filter and to a method for controlling the regeneration of a filter.

Compression ignition engines, called “diesel” engines, are known to produce a large quantity of soot. This results from the hydrocarbon pyrolysis occurring in the absence of oxygen and within the very combustion flame, and the insufficiently high temperature in the combustion chamber to burn all the soot particulates thereby produced. This soot, when emitted outside the vehicle, serves as seeds on which the unburnt hydrocarbons are condensed, thereby constituting inhalable solid particulates whose small size enables them to reach the lung cells.

To limit the emission of soot outside the vehicle and to meet the increasingly stringent environmental standards, it is known how to place filtration devices in the exhaust line, optionally associated with or including catalytic devices, the latter having the function of converting the polluting gas emissions to inert gases. Among the polluting gas emissions, mention can be made in particular of unburnt hydrocarbons and nitrogen oxides (NOₓ) or carbon monoxide (CO).

Soot filtration devices, commonly called “particulate filters” generally consist of a porous ceramic filter medium. This medium generally has a honeycomb structure, the exhaust gases to be filtered entering via one of the sides of said structure and the filtered exhaust gases exiting from the other side. Between these sides, respectively called the upstream and downstream sides in the rest of the text, the filter structure has a series of longitudinal and parallel channels separated by porous walls, said channels being blocked at one of their ends in order to force the exhaust gases to pass through said porous walls. For good overall gastightness, the peripheral part of the structure is surrounded by a cement called coating cement. The filter is also surrounded by a sheath, frequently called “canning” and consisting of a glass fiber mat and a metal envelope. In order to confer better thermal shock resistance, the filters sometimes consist of an assembly of monolithic and parallelepiped shaped elements called “segments” having a honeycomb structure, said elements being assembled using a cement. Examples of such filters, called “segmented” are described in patent applications EP 816 065, EP 1 142 619, EP 1 455 923 and also WO 2004/065088.

The ceramics most often used are cordierite (Mg₂Al₄Si₂O₁₈) or silicon carbide (SiC), the latter being preferred for its thermal conductivity and corrosion resistance properties.

During the running of the engine, the particulate filter is loaded with soot particulates, which deposit on the porous walls. Similarly as in the combustion chamber, the problem arises of the minimum temperature required for the combustion of the soot. The soot being retained in the filter, the combustion kinetics may be slower than in the combustion chamber, thereby lowering the soot combustion temperature to about 600° C. However, this gain is insufficient to ensure the combustion of the soot in the filter over the whole engine operating range. It is therefore necessary to provide a regeneration cycle after a filtration cycle, during which the soot is burned.

The particulate filter therefore operates by the following embodiments:
virtually simultaneous filtration and combustion of the soot if permitted by the exhaust gas temperature,
retention and accumulation of the soot particulates in the filter when the exhaust gas temperature is too low,
regeneration of the filter before the pressure drops due to the accumulation of soot become unacceptable.

The progressive clogging of the filter during the soot retention phase causes an increase in the pressure drop, resulting in an increase in the engine's fuel consumption.

The regeneration step takes place by increasing the temperature of the exhaust gases using a post-injection, which consists of the delayed injection in the engine cycle of the fuel, which burns in the exhaust line.

During the regeneration, and due to the exothermic combustion of the soot, the filter is subjected to high temperatures. These temperatures are also non-uniform in the material because the soot particulates are preferably deposited in the central part of the filter and also in its downstream portion, the filter is subjected to a high thermal shock, liable to cause micro-cracks in the material, causing a partial or total loss of its filtration capacity.

The more or less uniform character of the soot distribution in the filter is consequently a particularly important parameter to evaluate, because it has a direct influence on the thermal shock that the filter may be subjected to, and it is therefore an object of the invention to propose a method for evaluating the uniformity of the soot deposit in a particulate filter.

For this purpose, the invention relates to a method for measuring the uniformity of the deposit of soot in a particulate filter suitable for use in an engine exhaust line, comprising the steps consisting in measuring, simultaneously or in succession, the respective characteristic quantities of at least two gas streams each having passed through a different longitudinal portion of said filter, and then in comparing the characteristic quantities thus measured.

In the context of the present invention, “longitudinal portion” means a portion of the filter extending between its upstream and downstream sides parallel to the longitudinal channels.

A longitudinal portion may thus comprise a single longitudinal channel and also the porous walls of the filter which bound it, or a series of longitudinal channels. In the case in which the filter is segmented, a longitudinal portion may, for example, correspond to a segment.

The characteristic quantity of the gas flow is advantageously selected from the velocity or the flow rate, the velocity being particularly preferred because of the relative ease of its measurement.

The gas employed depends on the conditions for implementing the method. If the latter is used in line (that is in the exhaust line of the running engine), the gas is the exhaust gas of said engine. This type of measurement can also be taken off line, for example on a test bench, and a gas such as air may be employed.

The various measurements of the characteristic quantities of the flow can be taken in succession or simultaneously. The latter case is preferred because it does not require means for transverse movement of the measurement means.

The inventors have successfully determined that the quantity of soot present in a particulate filter varied linearly with the velocity or the flow rate of a gas stream having passed through said filter, thereby serving to accurately determine the first of these parameters by comparing the measured velocity with predefined values obtained, for example, after a calibration performed on a filter of the same type, taking account in particular of the pressure upstream of the filter. This velocity of flow rate measurement can also be taken to control the filter regeneration process more accurately and more reliably in comparison with the usual control methods involving the measurement of the pressure drop across the filter, because the variation in the pressure drop with the quantity of soot is not linear. The direct comparison between the velocities or flow rates of the various gas streams having passed through different longitudinal portions (for example different longitudinal channels) of the filter serves to evaluate the uniformity of the soot deposit in the filter, without prior calibration.

According to a first embodiment, a measurement is taken of the respective velocities of a series of gas streams each having passed through a different longitudinal portion of said filter, said longitudinal portions being spaced by a predefined pitch along an axis or along two perpendicular axes of a transverse plane. The pitch is then preferably equal to or smaller than the width of a longitudinal channel. A velocity mapping can also be made along a transverse plane and the uniformity of the soot deposit evaluated by various mathematical methods, such as the comparison between the extreme velocities, or the calculation of the standard deviation of the velocity distribution. This type of measurement can also be taken by taking account of the flow rate of the gas stream and not its velocity.

According to another embodiment, a measurement is taken of the respective velocity of two gas streams respectively having passed through a longitudinal portion located substantially at the center of the filter and a longitudinal portion located substantially at the periphery of said filter, and such that an absolute velocity difference AV, the latter quantity being characteristic of the uniformity of the filter. This method has the advantage of greater simplicity, because only two velocity measurement means are required. It also takes account of the fact that the soot is generally deposited in larger quantities at the center of the filter, the extreme velocity values therefore usually being observed respectively at the center and the periphery of the filter. Here also, a measurement of the flow rate of the gas stream can replace the measurement of the velocity of said stream.

The inventors have also determined that taking account of the measurement of the uniformity of the soot deposit in the filter serves to improve the regulation or control of regeneration.

The quantity of soot deposited is commonly evaluated in line by measuring the pressure drop, that is by measuring the pressure differential between the sides of the filter. It is currently according to this parameter that the regeneration conditions are determined, the regeneration being initiated or completed when the pressure drop reaches predefined values. However, the pressure drop measurement is only related to the total quantity of soot deposited in the filter and not to the uniformity of the soot deposit, and the inventors have demonstrated that a regeneration could be complete although a wide non-uniformity of the soot deposit subsisted, liable to damage the filter during a subsequent regeneration. Such a regeneration, qualified as imperfect in the rest of the text, is therefore detrimental to the long service life of the particulate filters.

It is therefore a further object of the invention to improve the control of the regeneration conditions in order to prevent the filter from undergoing excessive thermal shocks liable to embrittle it.

For this purpose, the invention relates to a method for controlling the regeneration of a particulate filter, comprising the steps consisting in measuring the uniformity of the soot deposit in said filter and in adjusting the parameters of said regeneration according to the uniformity value obtained.

An adjustment of the regeneration conditions as a function of the uniformity measurement accordingly serves to avoid imperfect regenerations. The filter is thereby spared from undergoing excessive thermal shocks, making it possible to lengthen the service life of the filters and/or allow the use of materials having poorer performance in terms of thermomechanical properties.

The regeneration parameters to be modified to prevent an imperfect regeneration from occurring are preferably the post-injection time and/or flow rate.

The measurement of the uniformity of the soot deposit in the particulate filter is preferably taken by the method previously described, that is by measuring the respective characteristic quantities of at least two gas streams each having passed through a different longitudinal portion of said filter, and then by comparing the characteristic quantities (such as flow rate or velocity) thus measured with one another.

The measurement of the uniformity of the soot deposit in the particulate filter is preferably not the only measurement which can be used to control the regeneration process. It is preferable for the regeneration to be partly controlled by known prior art methods, in particular methods using a pressure drop measurement or methods in which a regeneration is initiated when a given mileage has been traveled. The right moment for initiating and/or completing a regeneration may, for example, be partly determined by measuring the pressure drop across the filter and then by comparing the measured value with a predefined value. The measurement of the uniformity of the soot deposit may then be taken into account alternately or simultaneously:
occasionally at the start of a regeneration initiated by a pressure drop measurement, for example to control the post-injection flow rate,
occasionally on completion of a regeneration, determined by a pressure drop measurement, for example to decide whether or not to prolong the post-injection time.

According to a first embodiment, the uniformity of the soot deposit in the filter being measured at the start of regeneration, the post-injection flow rate is decreased if said uniformity is unsatisfactory, in particular if the measured value exceeds a predefined value. The decrease in the post-injection flow rate is carried out in relation to the value that this flow rate would have had without taking account of the uniformity of the soot deposit.

In a second embodiment, the uniformity of the soot deposit in the filter being measured at the end of regeneration, the post-injection time, generally a sufficient period for the uniformity to again become satisfactory. The method according to the invention then comprises a first step for diagnosing the imperfect nature of the regeneration that has taken place, particularly by comparison between the uniformity value obtained and a predefined value, and then, in the case in which the regeneration is diagnosed as imperfect, a second step of prolonging the post-injection time. The prolongation period may be predefined or correlated with the obtaining of an acceptable uniformity value. Simultaneously with the prolongation of the post-injection time, it is possible to adjust other regeneration parameters, for example to increase the post-injection flow rate.

The method according to the invention can be implemented in particular after a regeneration controlled in a known manner of the prior art, in particular by measuring the pressure drop across the filter, and it is only after the regeneration that the uniformity of the soot deposit is evaluated, and a correction made in the form of a prolongation of the post-injection time, optionally accompanied by an increase in the post-injection flow rate, if the latter has been judged imperfect. The post-injection prolongation period may be predefined: it may, for example, be a given percentage of the normal regeneration time. The regeneration may also be stopped when the uniformity value again becomes satisfactory, particular if it falls below a predefined value.

In particular, if the measurement of the uniformity of the soot deposit in the filter is taken by measuring the respective velocity of two gas streams having respectively passed through a longitudinal portion located substantially at the center of the filter and a longitudinal portion located substantially at the periphery of said filter, and the determination of an absolute velocity difference ΔV, it is preferably diagnosed that the regeneration is imperfect if the absolute velocity difference ΔV exceeds a predefined value ΔV₁, and, if the regeneration is diagnosed as imperfect, the post-injection time is increased by a period necessary for the absolute velocity difference ΔV to fall below a second predefined value ΔV₂. Alternatively, the post-injection time can be increased by a predefined period, a new measurement of the uniformity of the soot deposit being taken at the end of the prolonged regeneration, serving to determine whether the latter is still imperfect and whether a new prolongation of the post-injection time is necessary.

The predefined values discussed above may alternatively be fixed threshold values or values subject to modification according to the operating parameters of the engine and/or the filter. The precise determination of the ad hoc values is within the scope of a person skilled in the art, and it would be irrelevant to provide in the present specification precise values which only apply to particular cases.

According to another aspect, the present invention relates to a device for implementing the method for measuring the uniformity of the soot deposit or of the method for controlling the regeneration previously described.

Said methods can be implemented in various situations, such as for example “in line”, that is in an exhaust line of the engine of a motor vehicle or even (in the case of the uniformity measurement method) “off line”, in particular on a test bench designed for experimentally investigating the performance of a filter and/or the regeneration characteristics best adapted to a given filter.

In the latter case, such a device comprises in particular:
means for sending a gas such as air into the filter,
means for confining the air flow introduced into the filter,
means for regulating the flow rate and/or pressure of the air introduced into the filter,
means for measuring, at the filter outlet, a quantity characteristic of a stream of gas such as air passing through the filter element or elements.

If the characteristic quantity is the velocity, the measurement means are for example selected from vane anemometers, hot wires, Pitot tubes, hot ball systems, hot film systems, PIV (particle image velocimetry) type systems, LDA (laser Doppler anemometry) type systems measuring the Doppler effect associated with the air speed.

In the case of an in line implementation, the method according to the invention is advantageously implemented by using at least one means for measuring a characteristic quantity (for example velocity or flow rate) of a gas stream and optionally means for comparing and controlling the regeneration in an exhaust line of an engine, preferably a diesel engine.

A further subject of the invention is therefore an exhaust line of an engine (particularly diesel) comprising a particulate filter and at least one means for measuring the velocity or the flow rate of at least two gas streams each having passed through a different longitudinal portion of said filter.

The or each means for measuring the velocity or the flow rate of a gas stream is located immediately after the downstream side of the filter facing the corresponding longitudinal portion.

According to a first embodiment, the exhaust line comprises two means for measuring the gas stream velocity or flow rate, said means being fixed and located at the center and the periphery of the filter respectively.

According to a second embodiment, the exhaust line comprises means for measuring the velocity of a gas stream, said means being movable sideways. However, the first embodiment is preferred for reasons of easier implementation.

If the velocity is the characteristic quantity measured, the means for measuring the velocity of a gas stream is preferably a Pitot tube. The other means mentioned above may also be employed, but the Pitot tube is preferred, for reasons of cost, and because it can be made from a metal withstanding temperatures of over 1000° C.

In order to implement the regeneration control method according to the invention, the exhaust line preferably comprises a regeneration control system. This system comprises means for comparing the velocities of flow rates of exhaust gas streams in order to determine a uniformity value, means for comparing this uniformity value with a predefined value, and means for controlling the regeneration parameters, in particular its time and the post-injection flow rate.

The comparison means may consist of any type of onboard computer known to a person skilled in the art. The predefined values may alternately be fixed threshold values or values subject to modification according to the operating parameters of the engine and/or the filter.

The exemplary embodiments of the invention below illustrate the invention but without limiting it.

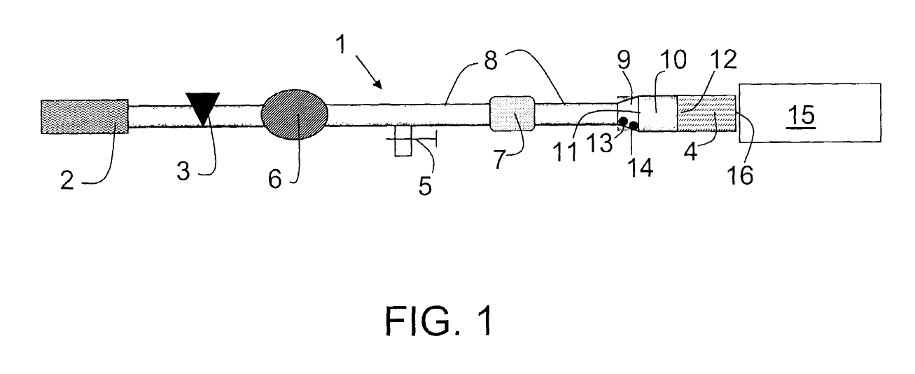

FIG. 1 shows a device for implementing the “off line” method for measuring the uniformity of the soot deposit.

### EXAMPLE 1

Example 1 concerns the “off line” implementation of the method for measuring the uniformity of a soot deposit and for diagnosing the state of regeneration of the filter.

In this example, a particulate filter is loaded with soot and then regenerated on an engine test bench by a protocol that is described below. The uniformity of the soot deposit is then measured using the device in FIG. 1, described in detail below.

The filter employed combines a plurality of monolithic honeycomb elements in a filter block. The extruded elements are made from recrystallized silicon carbide (R—SiC). After firing, they are machined and assembled together by bonding using a silicon carbide SiC based cement, the structure thereby obtained then being coated with a coating cement, using well known techniques. The fabrication of such filter structures is described in particular in patent applications EP 816 065, EP 1 142 619, EP 1 455 923 or even WO 2004/065088.

Its geometric characteristics are given in Table 1:

TABLE 1

| | |
|---|---|
| Channel geometry | Square |
| Channel density | 311 cpsi |
| | (channel per square inch, |
| | 1 inch = 2.54 cm) |
| Wall thickness | 280 μm |
| Number of elements | 16 |
| assembled | |
| Shape of structure | Cylindrical |
| Length | 6″ (15.2 cm) |
| Volume | 2.47 liters |

The engine test bench employed for loading the filter with soot and for regeneration comprises a diesel engine with 2.0 L cubic capacity and direct injection. The fuel used is a diesel fuel containing less than 50 ppm sulfur.

During the soot loading, the engine operating point is as follows: speed 3000 rev/min for a torque of 50 Nm.

During the regeneration, the speed is 1700 rev/min for a torque of 95 Nm. A regeneration cycle called normal comprises a post-injection of about 10 minutes.

After the soot loading and/or regeneration, the uniformity of the soot deposit is evaluated “off line” using the device in FIG. 1.

This device comprises a tubular member 1 on which the following are placed in succession:

1) an air filter 2:

This filter is optional and has the function of preventing the accumulation in the system of dust present in the ambient air.

2) a butterfly valve 3:

This valve serves to roughly control the flow rate and pressure at the inlet of the particulate filter 4.

However, for the lowest values of the air flow rate, it may be advantageous to couple this valve 3 with a precision valve 5. This valve 5 is for example of the guillotine type and serves to operate with an air flow having a substantially constant temperature. The addition of this valve 5 advantageously allows for a flow rate accuracy better than 1 m³/h (cubic meters per hour) and an easier regulation of the pressure close to and upstream of the particulate filter 4, in the air flow direction. The accuracy on the pressure obtained is about 1 mbar (1 bar=0.1 MPa).

3) a blower 6:

The blower serves to propel the air into the filter 4. The maximum blown air flow rate is 350 m³/h.

4) a flowmeter 7:

The flowmeter serves to check and control the air flow rate during the handling.

5) a length of tube 8 adjusted between the blower 6 and the divergent nozzle 9:

The length of the tube 8 between the blower and the divergent nodule is advantageously higher than 50 times the tube diameter. This configuration serves in particular to obtain a substantially constant velocity of the gas flow lines at the outlet of the tube 8, that is a stabilized flow of gas at the inlet of the divergent nozzle.

6) a divergent nozzle 9:

To prevent any detachment of the air flow at the walls of the divergent nozzle and any turbulence, the divergent apex angle is preferably lower than 7°, for example 6°. This configuration serves in particular to obtain a uniformity of the gas flow lines arriving at the inlet of the particulate filter.

In a preferred embodiment of the invention, the filter inlet and the divergent nozzle outlet are directly joined. However, it would still be within the scope of the invention if the envelope 10 of the filter (called “canning” in the art) had a length greater than that of the filter 4, so that a space exists between the outlet 11 of the divergent nozzle 9 and the inlet 12 of the filter 4. For example, tests conducted by the Applicant have demonstrated satisfactory results when a 6″ long filter (1 inch=2.54 cm) was placed at a distance of 4″ from the filter inlet, involving the use of a 10″ long canning (see FIG. 1).

7) a pressure sensor 13:

The pressure sensor has the function of checking and controlling the absolute and/or gauge pressure in the part of the divergent nozzle located immediately upstream of the particulate filter, in the air flow direction.

8) optionally a temperature sensor 14 close to the inlet of the filter 12.
9) a system 15 for measuring the air speed:

The measurement system may be selected according to the invention from any system known in the field of fluid mechanics for measuring the velocity of a gas stream. It is for example possible according to the invention to use the following, without this being considered as restrictive:
one or more vane anemometers sweeping the downstream surface of the particulate filter at the outlet of the present device,
a series or battery of anemometers fixed or mobile and/or placed at various locations at the back of the filter,
one or more hot wires, or even a set of hot wires, the gas velocity being measured as a function of the heat loss of the wire or wires,
one or more Pitot tubes,
hot ball systems,
hot film systems,
PIV (particles image velocimetry) type systems,
LDA (laser Doppler anemometer) type systems measuring the Doppler effect associated with the air speed.

A preferred measurement system 15 consists of a mobile anemometer in a transverse plane.

The distance between the back 16 of the filter and the air measurement system 15 is generally a compromise between the space required by the dimensions of the measurement system itself and the power of the air stream at the filter outlet.

In practice, a configuration is selected in which this distance is minimized to avoid any “backmixing” of the outlet gas streams which are liable to hinder the measurement of the gas velocity.

In general, the filter/measurement system distance is between 0 and a few centimeters, preferably between 0 and 2 cm.

For the implementation of example 1, the divergent nozzle has an apex angle of 6°. The gas velocity measurement system consists of a Schiltknecht make vane anemometer sold by RBI Instrumentations, mounted on two cylinders placed in a cross, thereby allowing its movement along two travel axes X and Y of the transverse plane. The anemometer, having a diameter of 9 mm, is located 2 mm from the front side of the filter. The filter upstream pressure is 12 mbar.

The system makes a stepwise movement on a first line in the X direction, the step being set at 1.8 mm. The step is selected as equal to the width of a channel, in order to obtain an optimal discrimination. Once the line along X is completed, the system descends by one notch along Y. At each movement of the anemometer in the X or Y direction, a local measurement is taken of the gas velocity. A complete X Y mapping of the streams is thus obtained.

The filter is loaded with three different levels of soot: 0.69 g/L, 1.46 g/L and 5.54 g/L (grams of soot per liter of filter).

Table 2 below shows the velocities measured downstream of the filter, at the centre and at the periphery of the filter for each of the soot loading levels. More precisely, the three measurements are taken on a line of the X axis, for values of X, respectively of 2.5 cm (P₁), 8.5 cm (C) and 12.5 cm (P₂). The last column indicates the relative velocity variation between the center and the periphery of the filter, expressed in percent.

TABLE 2

| Velocity (m/s) | P₁ | C | P₂ | C/P |
|---|---|---|---|---|
| 0.69 g/L | 9.8 | 9.6 | 9.7 | 2% |
| 1.46 g/L | 5.2 | 5.0 | 5.2 | 4% |
| 5.54 g/L | 1.0 | 0.6 | 1.0 | 40% |
| 7.00 g/L | 0.7 | 0.4 | 0.7 | 43% |

The results show that the air velocity downstream of the filter varies according to the quantity of soot deposited in the filter. It may also be observed that for low values of soot quantities (0.69 and 1.46 g/L), the deposit is relatively uniform between the centre and the periphery of the filter, since the velocity values are substantially identical. On the other hand, it may be observed that for high quantities of soot, in the loading conditions used, the deposit is very non-uniform, with larger quantities being deposited at the center of the filter. The non-uniformity of the deposit is therefore characterized here by the comparison of two or three flow velocities of a gas (in this case air) having passed through two or three different longitudinal portions of the filter.

### EXAMPLE 2

This example illustrates the “in line” implementation of the methods for measuring the uniformity of the soot deposit and for controlling the regeneration according to the invention.

A particulate filter is subjected to a certain number of cycles each comprising a soot loading of 7 g/L followed by a regeneration. According to a first comparative embodiment, the regeneration is only controlled by the measured pressure drop. According to an embodiment of the invention, the regeneration conditions are also controlled by measuring the uniformity of the soot deposit in the filter.

In this example, the particulate filter employed is similar to that of example 1. The same engine text bench is also employed, but the difference that the exhaust line now comprises two Pitot tubes downstream of the filter and placed at the centre and periphery of the filter respectively. These Pitot tubes serve for the in line measurement of the velocity of two exhaust gas streams each having passed through a respectively central and peripheral longitudinal portion of the filter. The uniformity of the soot deposited in the filter is characterized as being the absolute value of the velocity difference ΔV in between the two measured velocities. The exhaust line therefore comprises means for comparing the two measured velocities, for calculating the value of value of ΔV and for comparing this value with a predefined value, and also means for controlling certain regeneration parameters when the value of ΔV exceeds this predefined value, attesting to an excessive non-uniformity of the soot deposit.

A “pressure drop efficiency” or even “ΔP efficiency” is defined by the ratio between the value of the pressure drop after the soot loading less the value of the pressure drop after regeneration, and the value of the pressure drop after the soot loading less the value of the pressure drop of a new filter. The regeneration is initiated when the pressure drop efficiency is lower than the predefined value, in this case 90%, corresponding here to a quantity of soot of 7 g/L.

After the soot loading, a regeneration called normal is initiated, comprising as for example 1 a post-injection of 10 minutes for an engine speed corresponding to a speed of 1700 rev/min and a torque of 95 Nm. This regeneration serves to restore the value of the pressure drop to a value corresponding to a DP efficiency of 90% or more.

According to the comparative embodiment of the example, the regeneration parameters are not modified as a function of the uniformity of the soot deposit.

According to the embodiment of the invention, if, after a normal regeneration (being determined by the measurement of the ΔP efficiency) the value of ΔV is higher than the predefined value ΔV₁ equal to 2 m/s, (corresponding to an imperfect regeneration) a prolongation of the post-injection time of about 20% is applied. This increase in the time is selected because it serves to strongly lower the value of ΔV. It is obvious that other protocols for implementing the invention can be selected and adapted according to the operating conditions (type of engine and filter, etc.). In particular, the prolongation of the post-injection time may be accompanied by an increase in the post-injection flow rate. The prolongation time may not be fixed but may be associated with a certain value ΔV₂, the regeneration being stopped when the value of ΔV falls below this value ΔV₂.

Tables 3 and 4 show the results obtained respectively for the comparative embodiment and the embodiment according to the invention.

In both cases, the filter has undergone 8 cycles each comprising a soot loading and a regeneration as defined previously.

For each cycle, the tables provide various data measured at the end of normal regeneration: the ΔP efficiency, the value of ΔV, and if applicable, the prolongation of the post-injection time compared with the normal time, the latter corresponding to 10 minutes.

TABLE 3
(comparative embodiment)

| Cycle No. | 1 | 2 | 3 | 4 | 5 | 6 | 7 | 8 |
|---|---|---|---|---|---|---|---|---|
| ΔP | 95 | 93 | 92 | 94 | 92 | 90 | 92 | 98 |
| efficiency (%) | | | | | | | | |
| ΔV (m/s) | 0.5 | 0.8 | 1.0 | 1.3 | 1.8 | 2.4 | 2.9 | 0.4 |

The high values of the pressure drop efficiency after the regeneration show that the regeneration is effective in terms of decreasing the total quantity of soot. However, a high increase is correlatively observed in the velocity differential between the center and the periphery ΔV from one cycle to another, which demonstrates a degradation of the uniformity of the soot distribution in the filter. The 6^{th} and 7^{th} regenerations can be qualified as imperfect in the test conditions, because they are associated with a velocity differential higher than 2 m/s. On completion of the 8^{th} regeneration, however, the uniformity returns to a satisfactory value. The examination of the filter shows that a sudden clearing of the filter has occurred, accompanied by a cracking of the filter.

Controlling the regeneration by measuring the pressure drop alone and without taking account of the uniformity of the soot deposit in the filter is therefore liable to create imperfect regenerations associated with a high and non-uniformity of the soot deposit, liable to give rise to thermal shocks and mechanical degradation of the filters during subsequent regenerations.

Table 4 illustrates the embodiment according to the invention.

TABLE 4
(comparative embodiment)

| Cycle No. | 1 | 2 | 3 | 4 | 5 | 6-1 | 6-2 | 7 | 8 |
|---|---|---|---|---|---|---|---|---|---|
| ΔP efficiency (%) | 96 | 94 | 92 | 90 | 92 | 93 | 98 | 95 | 93 |
| ΔV (m/s) | 0.3 | 0.6 | 1.0 | 1.5 | 1.9 | 2.2 | 0.2 | 0.5 | 0.8 |
| Post-injection time | — | — | — | — | — | — | +20% | | |

Unlike the comparative embodiment shown in Table 3, the regeneration parameters, here the post-injection time, are modified after a normal regeneration diagnosed as imperfect, in particular if the non-uniformity of the soot deposit in the filter is too high.

After the 6^{th} normal regeneration, denoted 6-1, the value of ΔV of 2.2 is higher than the predefined value ΔV₁ of 2. This regeneration then being diagnosed as imperfect, a 20% increase in the post-injection time is applied. This second part of the 6^{th} cycle, denoted 6-2, serves to restore the value of ΔV to an acceptable value and a second prolongation of the post-injection time is therefore not applied.

After the 8^{th} regeneration, the filter does not present any cracking or any mechanical embrittlement. The method for diagnosing and controlling the regeneration according to the invention therefore serves to increase the service life of the particulate filters and/or to allow the use of materials having poorer performance in terms of thermomechanical properties.

1: A method for measuring the uniformity of the deposit of soot in a particulate filter, comprising
measuring, simultaneously or in succession, the respective characteristic quantities of at least two gas streams each having passed through a different longitudinal portion of said filter, and comparing the characteristic quantities thus measured with one another.

2: The method as claimed in claim 1, wherein the characteristic quantity is the velocity of the flow rate.

3: The method as claimed in claim 2, wherein a measurement is taken of the respective velocities of a series of gas streams each having passed through a different longitudinal portion of said filter, said longitudinal portions being spaced by a predefined pitch along an axis or along two perpendicular axes of a transverse plane.

4: The method as claimed in claim 3, wherein the pitch is equal to or smaller than the width of a longitudinal channel.

5: The method as claimed in claim 2, wherein a measurement is taken of the respective velocity of two gas streams respectively having passed through a longitudinal portion located substantially at the center of the filter and a longitudinal portion located substantially at the periphery of said filter, and such that an absolute velocity difference ΔV is determined.

6: A method for controlling regeneration of a particulate filter, comprising:
measuring the uniformity of soot deposit in said filter and adjusting parameters of said regeneration according to the uniformity value obtained.

7: The method as claimed in claim 6, wherein the measurement of uniformity of the soot deposit in the particulate filter is taken using the method as claimed in claim 1.

8: The method as claimed in claim 6, wherein the uniformity of the soot deposit in the filter is measured at the start of regeneration, and the post-injection flow rate is decreased if said uniformity is unsatisfactory.

9: The method as claimed in claim 6, wherein the uniformity of the soot deposit in the filter is measured at the end of regeneration, and the post-injection time is prolonged if said uniformity is unsatisfactory.

10: The method as claimed in claim 9, wherein a measurement is taken of the uniformity of the soot deposit in the filter by the method as claimed in claim 5 at the end of regeneration and that, if the absolute velocity difference ΔV exceeds a predefined value ΔV₁, the post-injection time is increased by a period necessary for the absolute velocity difference ΔV to fall below a second predefined value ΔV₂.

11: An exhaust line of an engine, comprising a particulate filter and at least one means for measuring the velocity or the flow rate of at least two gas streams each having passed through a different longitudinal portion of said filter.

12: The exhaust line as claimed in claim 11, wherein the at least one means for measuring the velocity or the flow rate of a gas stream is located immediately after the downstream side of the filter facing the corresponding longitudinal portion.

13: The exhaust line as claimed in claim 11, comprising two means for measuring the gas stream velocity or flow rate, said means being fixed and located at the center and the periphery of the filter respectively.

14: The exhaust line as claimed in claim 11, comprising means for measuring the velocity of a gas stream, said means being movable sideways.

15: The exhaust line as claimed in claim 11, further comprising a regeneration control system, which comprises means for comparing the velocities of flow rates of exhaust gas streams in order to determine a uniformity value, means for comparing this uniformity value with a predefined value, and means for controlling the regeneration parameters.

16: The exhaust line as claimed in claim 11, wherein the at least one means for measuring the velocity of a gas stream is a Pitot tube.
